(19) United States
(12) Patent Application Publication
(10) Pub. No.: US 2023/0097810 A1
(43) Pub. Date: Mar. 30, 2023

(54) Dog Retrieval Tool Device

(71) Applicant: Jeremy Baker, Centerton, AR (US)

(72) Inventor: Jeremy Baker, Centerton, AR (US)

(21) Appl. No.: 17/498,012

(22) Filed: Oct. 11, 2021

Related U.S. Application Data
(60) Provisional application No. 63/247,836, filed on Sep. 24, 2021.

(51) Int. Cl. A01K 15/02

(52) U.S. Cl. CPC A01K 15/025

(57) ABSTRACT

The present invention relates to a dog retrieval tool device primarily comprised of a hollow body that has a first end, a second end, and a central recessed area. In differing embodiments, the body may be filled with water and/or air and may have the appearance of a plurality of differing waterfowls or colors known in the art. In order to allow a user to easily throw the device, the device is further comprised of a rope with a slip-resistant handle. Further, the body of the device is comprised of a padded neoprene cover that encapsulates the body. In this manner, the cover ensures the teeth and gums of a dog are not injured, when a dog bites the device.

### CROSS-REFERENCE TO RELATED APPLICATION

The present application claims priority to, and the benefit of, U.S. Provisional Application No. 63/247,836 which was filed on Sep. 24, 2021 and is incorporated herein by reference in its entirety.

### FIELD OF THE INVENTION

The present invention relates generally to the field of dog retrieval toys. More specifically, the present invention relates to a dog retrieval tool device primarily comprised of a hollow body that has a first end, a second end and a central recessed area. In differing embodiments, the body may be filled with water and/or air and may have the appearance of a plurality of differing waterfowls or colors known in the art. In order to allow a user to easily throw the device, the device is further comprised of a rope with a slip-resistant handle. Accordingly, the present disclosure makes specific reference thereto. Nonetheless, it is to be appreciated that aspects of the present invention are also equally applicable to other like applications, devices and methods of manufacture.

### BACKGROUND

Plastic retrieval tools, or “bumpers”, are used as a training tool to train dogs to retrieve waterfowl. Bumpers are used in place of actual waterfowl and are often used in repetitive drills to teach a dog to retrieve waterfowl. Bumpers further float, such that they can be thrown into a body of water to teach a dog to fetch waterfowl after the fowl has been shot and is floating in a body of water. Training a dog to retrieve waterfowl is preferably done at as young of an age as possible. However, dogs who may be between 2 and 6 months of age do not yet have their adult teeth. As a result, a large area of the gumline of the dog is exposed and is extremely sensitive. Therefore, the gums of young dogs can become extremely sore when repeatedly biting a hard, plastic bumper during retrieving training. Further, bleeding of the gums and the premature loss of baby teeth can also occur. Because of this, a young dog may refuse to partake in retrieval training, which is undesirable for the dog owner.

Therefore, there exists a long-felt need in the art for an improved bumper tool that allows a user to train a dog to retrieve waterfowl. There also exists a long-felt need in the art for a dog retrieval tool device that allows a user to train a dog to retrieve waterfowl but does not injure the sensitive teeth and gums of a young dog. Finally, there exists a long-felt need in the art for a dog retrieval tool device that floats, such that the device can be thrown into a body of water.

The subject matter disclosed and claimed herein, in one embodiment thereof, comprises a dog retrieval tool device. The device is primarily comprised of a hollow body that has a first end, a second end and a central recessed area. In differing embodiments, the body may be filled with water and/or air and may have the appearance of a plurality of differing waterfowls or colors known in the art. In order to allow a user to easily throw the device, the device is further comprised of a rope with a slip-resistant handle. Further, the body of the device is comprised of a padded neoprene cover that encapsulates the body. In this manner, the cover ensures the teeth and gums of a dog are not injured, when a dog bites the device.

In this manner, the dog retrieval tool device of the present invention accomplishes all of the forgoing objectives and provides an improved tool that allows a user to train a dog to retrieve waterfowl, wherein the device does not injure the sensitive teeth and gums of a young dog when the dog bites the device. Further, the device floats, such that the device can be thrown into a body of water. In this manner, the dog retrieval tool device overcomes the limitations of existing bumper tools known in the art that injure the teeth and gums of dogs.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a dog retrieval tool device primarily comprised of a hollow body that has a first end, a second end and a central recessed area. The body is preferably tubular in shape and is manufactured from a lightweight plastic material. In addition, the body may also be shaped as the body of a waterfowl, such as but not limited to, various species of duck or goose. The first end and second end may further detachably-attach to the central recessed area of the body in a cap-like fashion, such that both ends can be removed for cleaning. However, in the preferred embodiment, both ends are fixedly-attached to the central recessed area to form one continuous body. The second end is further comprised of a protrusion that has a continuous opening which allows a rope to be tied to the device. The rope can be knotted, such that it is secured through the opening or may removably-attach via a clip or clasp. In this manner, a user can grasp the rope in order to throw the device, to allow a dog to retrieve the device. The second end is further comprised of a recessed, removable valve that can be opened, such that the hollow body can be filled with water and/or air, such that it becomes heavier and/or more buoyant and can be thrown a further distance in an easier manner. In lieu of air/water, at least one weight may further be placed within the body, after the valve is opened and/or removed.

The device is further comprised of a cover that can be placed over the body. The cover may only cover the central recessed area and sit flush with both ends or may cover the entire body. In order to allow the cover to be removably-attached around the body, the cover has at least one fastener that runs along the length of the cover, that in differing embodiments may be any fastener known in the art such as, but not limited to, a seam, a zipper assembly, a snap-button assembly, a hook and loop assembly, a magnetic assembly, a button and loop assembly, etc. The cover is preferably manufactured from a soft, padded material, such as but not limited to, neoprene, etc., or any other suitable material as is known in the art, that does not injure or irritate the teeth or gums of a dog when the cover is bitten by a dog during the retrieval process. The cover and/or body may be manufactured in any color known in the art and may also have any pattern or print known in the art, such as but not limited to, camouflage or any print that mimics the feathers/appearance of a waterfowl. One embodiment of the cover and/or body may have a plurality of fixedly-attached, synthetic, waterfowl feathers that are attached to the cover in order to closely mimic the appearance of any waterfowl. In addition, the cover may have a plurality of indicia, such as patterns, logos, emblems, images, symbols, designs, letters, words, characters, animals, advertisements, brands, the name or the nickname of at least one dog, etc.

Accordingly, the dog retrieval tool device of the present invention is particularly advantageous as it allows a user to train a dog to retrieve waterfowl but does not injure the sensitive teeth and gums of a young dog, when the dog bites the device. Further, the device floats, such that the device can be thrown into a body of water. In this manner, the dog retrieval tool device overcomes the limitations of existing bumper tools known in the art, that injure the teeth and gums of dogs.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of the dog retrieval tool device of the present invention in accordance with the disclosed architecture;

FIG. 2 illustrates a perspective view of one potential embodiment of the dog retrieval tool device of the present invention without a cover attached thereto in accordance with the disclosed architecture; and

FIG. 3 illustrates a perspective view of one potential embodiment of the dog retrieval tool device of the present invention with a cover attached in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for an improved bumper tool that allows a user to train a dog to retrieve waterfowl. There also exists a long-felt need in the art for a dog retrieval tool device that allows a user to train a dog to retrieve waterfowl, but does not injure the sensitive teeth and gums of a young dog. Finally, there exists a long-felt need in the art for a dog retrieval tool device that floats, such that the device can be thrown into a body of water.

The present invention, in one exemplary embodiment, is comprised of a dog retrieval tool device primarily comprised of a hollow body that has a first end, a second end and a central recessed area. The body is preferably tubular in shape and is manufactured from a lightweight plastic material. The body may also be shaped as the body of a waterfowl, such as but not limited to, various species of duck or goose. The first end and second end of the body may further detachably-attach to the central recessed area of the body in a cap-like fashion, such that both ends can be removed for cleaning. However, in the preferred embodiment, both ends are fixedly-attached to the central recessed area to form one continuous body.

The second end is also comprised of a protrusion that has a continuous opening which allows a rope to be tied to the device. The rope can be knotted, such that it is secured through the opening or may removably-attach via a clip or clasp. In this manner, a user can grasp the rope in order to throw the device, to allow a dog to retrieve the device. The second end is also comprised of a recessed, removable valve that can be opened, such that the hollow body can be filled with water and/or air, such that it becomes heavier and/or more buoyant and can be thrown a further distance in an easier manner. In lieu of air/water, at least one weight may further be placed within the body after the valve is opened and/or removed.

A cover can also be placed over the body. The cover may only cover the central recessed area and sit flush with both ends or may cover the entire body. In order to allow the cover to be removably-attached around the body, the cover has at least one fastener that runs along the length of the cover that in differing embodiments may be any fastener known in the art, such as but not limited to: a seam, a zipper assembly, a snap-button assembly, a hook and loop assembly, a magnetic assembly, a button and loop assembly, etc. The cover is preferably manufactured from a soft, padded material, such as but not limited to neoprene, that does not injure or irritate the teeth or gums of a dog, when the cover is bitten by a dog during the retrieval process. The cover and/or body may be manufactured in any color known in the art and may also have any pattern or print known in the art, such as but not limited to, camouflage or any print that mimics the feathers/appearance of a waterfowl. One embodiment of the cover and/or body may have a plurality of fixedly-attached, synthetic, waterfowl feathers that are attached to the cover in order to closely mimic the appearance of any waterfowl. In addition, the cover may have a plurality of indicia, such as, patterns, logos, emblems, images, symbols, designs, letters, words, characters, animals, advertisements, brands, the name or the nickname of at least one dog, etc.

Accordingly, the dog retrieval tool device of the present invention is particularly advantageous as it allows a user to train a dog to retrieve waterfowl but does not injure the sensitive teeth and gums of a young dog when the dog bites the device. Further, the device floats, such that the device can be thrown into a body of water. In this manner, the dog retrieval tool device overcomes the limitations of existing bumper tools known in the art that injure the teeth and gums of dogs.

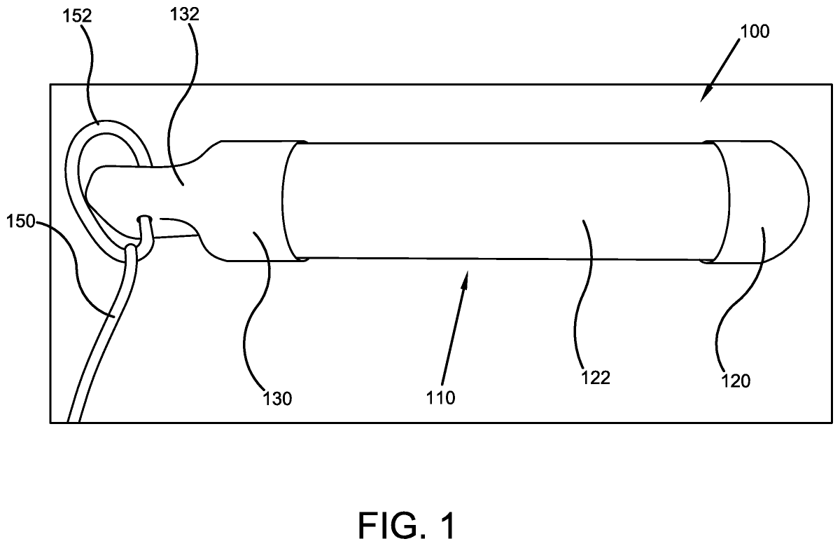

Referring initially to the drawings, FIG. 1 illustrates a perspective view of one embodiment of the dog retrieval tool device 100 of the present invention. The device 100 is primarily comprised of a hollow body 110 that has a first end 120, a second end 130 and a central recessed area 122 between both ends 120, 130. The body 110 is preferably tubular in shape, and is manufactured from a lightweight plastic material such as, but not limited to, an acrylic, polycarbonate, polyethylene, thermoplastic, acrylonitrile butadiene styrene, low density polyethylene, medium density polyethylene, high density polyethylene, polyethylene terephthalate, polyvinyl chloride, polystyrene, polylactic acid, acetal, nylon, fiberglass, etc., or any other suitable material as is known in the art.

However, the body 110 may also be a plurality of other tubular-like shapes, such as but not limited to, a square, octagonal, hexagonal, triangular, etc., or any other suitable shape as is known in the art. Further, the body 110 may be shaped as the body of a waterfowl, such as but not limited to, various species of duck or goose. The first end 120 and second end 130 may further be detachably-secured to the central recessed area 122 of the body in a cap-like fashion, such that both ends 120, 130 can be removed for cleaning. However, in a preferred embodiment, both ends 120, 130 are fixedly-secured to the central recessed area 122 to form one continuous body 110. In differing embodiments, the body 110 may be completely smooth or may be textured (i.e., having ridges and/or valleys). Further, any embodiment of the device 100 is preferably waterproof and/or water-resistant.

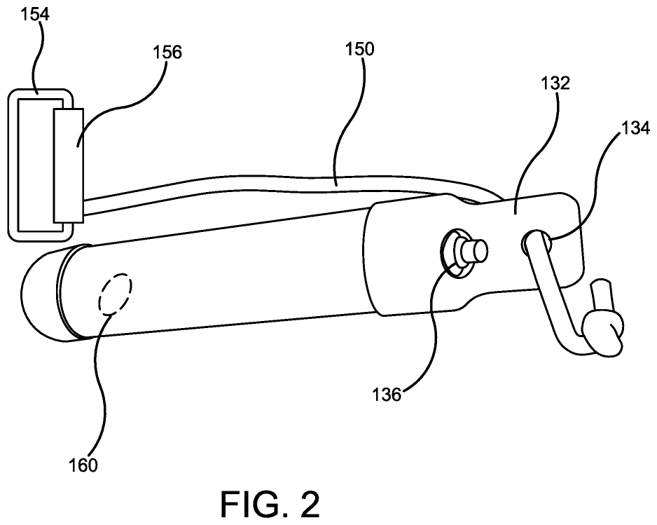

FIG. 2 illustrates a perspective view of one embodiment of the dog retrieval tool device 100 of the present invention without a cover 140 attached. The second 130 end is further comprised of a protrusion 132 that is preferably rectangular in shape, but can be any other suitable shape as is known in the art. The protrusion 132 is further comprised of a continuous opening 134. The opening 134 further allows a rope 150 to be tied to the device 100. In differing embodiments, the rope 150 may be made of a plurality of materials such as, but not limited to, a manila hemp, hemp, linen, cotton, coir, jute, straw, sisal, polypropylene, nylon, polyesters, polyethylene, aramids, or acrylic material, etc., or any other suitable material as is known in the art. The rope 150 can be knotted, such that it is secured through the opening 134 or may be removably-attached via a clip 152 or clasp, such as but not limited to, a D-clip or other similar clip/clasp of the like. In this manner, a user can grasp the rope 150 to throw the device 100, to allow a dog to retrieve the device 100. To further aid a user in grasping the rope 150, the rope 150 may have a handle 154, that is comprised of a textured and slip-resistant grip 156.

The second end 130 is further comprised of a recessed, removable valve 136. The valve 136 can be opened, such that the hollow body 110 is filled with water and/or air. To this effect, the body 110 becomes heavier and/or more buoyant, such that it can be thrown a long distance in an easy manner. In lieu of air and/or water, at least one weight 160 may be placed within the body 110, after the valve 136 is opened and/or removed. One embodiment of the device 100 may also have a kit of a plurality of weights 160 of differing sizes, weights and buoyancies which can be placed within the body 110.

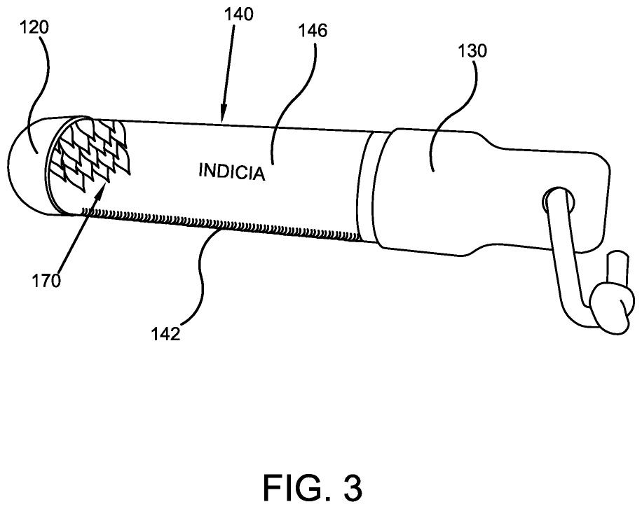

FIG. 3 illustrates a perspective view of one embodiment of the dog retrieval tool device 100 of the present invention with a cover 140 attached. The device 100 comprises a cover 140 that can be placed over the body 110. In differing embodiments, the cover 140 may only cover the central recessed area 122, wherein the cover 140 sits flush with both ends 120, 130, or may cover the entire body 110 (i.e., both ends 120, 130 and the central area 122). In order to allow the cover 140 to be removably-attached around the body 110, the cover 140 comprises at least one fastener 142 that runs along the length of the cover 140. In differing embodiments, the fastener 142 may be any fastener known in the art such as, but not limited to, a seam, a zipper assembly, a snap-button assembly, a hook and loop assembly, a magnetic assembly, a button and loop assembly, etc. In this manner, the cover 140 can be removed from the body 110 as needed, to be washed, cleaned or replaced.

The cover 140 is preferably manufactured from a soft, padded material, such as but not limited to, neoprene, which does not injure or irritate the teeth or gums of a dog when the cover 140 is bitten by a dog during the retrieval process. The cover 140 may be of any desired circumference and have any amount of padding desired by a user to protect the teeth and gums of a dog. Further, the cover 140 and/or body 110 may be manufactured in any color known in the art. The cover 140 and/or body 110 may also have any pattern or print known in the art, such as but not limited to, camouflage or any print that mimics the feathers/appearance of a waterfowl. One embodiment of the cover 140 and/or body 110 may have a plurality of fixedly-attached, synthetic, waterfowl feathers 170, that are attached to the cover 140 in order to closely mimic the appearance of various waterfowl. Furthermore, the cover 140 may have a plurality of indicia 146, such as patterns, logos, emblems, images, symbols, designs, letters, words, characters, animals, advertisements, brands, the name or the nickname of at least one dog, etc.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “dog retrieval tool device” and “device” are interchangeable and refer to the dog retrieval tool device 100 of the present invention.

Notwithstanding the forgoing, the dog retrieval tool device 100 of the present invention and its various components can be of any suitable size and configuration as is known in the art without affecting the overall concept of the invention, provided that they accomplish the above-stated objectives. One of ordinary skill in the art will appreciate that the size, configuration and material of the dog retrieval tool device 100 as shown in FIGS. 1-3 is for illustrative purposes only, and that many other sizes and shapes of the dog retrieval tool device 100 are well within the scope of the present disclosure. Although the dimensions of the dog retrieval tool device 100 are important design parameters for user convenience, the dog retrieval tool device 100 may be of any size, shape and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A dog retrieval tool device comprising:
a body having a first end, a second end, and a central recessed area positioned between the first end and the second end;
a cover;
a rope that attaches to the second end; and
a handle attached to the rope.

2. The dog retrieval tool device of claim 1, wherein the cover can be removably attached to the body, such that is covers the central recessed area.

3. The dog retrieval tool device of claim 1, wherein the cover can be removably attached to the body, such that is covers the central recessed area and the first end and the second end.

4. The dog retrieval tool device of claim 3, wherein the cover is secured around the body via a fastener selected from a group consisting of a seam, a zipper assembly, a snap-button assembly, a hook and loop assembly, a magnetic assembly and a button and loop assembly.

5. A dog retrieval tool device comprising:
a waterproof body that is shaped like a waterfowl, the waterproof body comprising a first end, a second end and a central recessed area positioned between the first end and the second end, wherein the second end comprises a protrusion having a continuous opening;
a cover that is removably attached to the waterproof body via at least one fastener, the cover comprising a plurality of synthetic waterfowl feathers;
a removable valve; and
a rope comprising a slip-resistant grip, wherein the rope attaches to the second end through the continuous opening.

6. The dog retrieval tool device of claim 5, wherein the cover is a manufactured from a neoprene material.

7. The dog retrieval tool device of claim 6, wherein the cover is secured around the waterproof body via a fastener selected from a group consisting of a seam, a zipper assembly, a snap-button assembly, a hook and loop assembly, a magnetic assembly and a button and loop assembly.

8. A dog retrieval tool device that allows a user to train a dog to retrieve a waterfowl without injuring the dog, the dog retrieval tool device comprising:
a waterproof body comprising a first end, a second end, and a central recessed area positioned between the first end and the second end, wherein the second end comprises a protrusion having a continuous opening;
a cover removably attached to the waterproof body via at least one fastener;
a removable valve; and
a rope comprising a slip-resistant grip, wherein the rope attaches to the second end through the continuous opening.

9. The dog retrieval tool device of claim 8, wherein the waterproof body is manufactured from a lightweight plastic material.

10. The dog retrieval tool device of claim 8, wherein the rope can attach to the continuous opening of the second end by being knotted or by a clip.

11. The dog retrieval tool device of claim 8, wherein the removable valve can be opened to allow a water, an air or at least one weight to enter into the waterproof body.

12. The dog retrieval tool device of claim 8, wherein the cover is manufactured from a padded neoprene material.

13. The dog retrieval tool device of claim 8, wherein the cover covers the central recessed area.

14. The dog retrieval tool device of claim 8, wherein the cover covers the central recessed area and the first end and the second end.

15. The dog retrieval tool device of claim 8, wherein the at least one fastener is a seam, a zipper assembly, a snap-button assembly, a hook and loop assembly, a magnetic assembly or a button and loop assembly.

16. The dog retrieval tool device of claim 8, wherein the cover can comprise a plurality of colors.

17. The dog retrieval tool device of claim 8, wherein the cover comprises a pattern or a print.

18. The dog retrieval tool device of claim 17, wherein the pattern or the print mimics the waterfowl in appearance.

19. The dog retrieval tool device of claim 8, wherein the cover is further comprised of a plurality of indicia

20. The dog retrieval tool device of claim 19, wherein the plurality of indicia comprise at least two of a pattern, a logo, an emblem, an image, a symbol, a design, a letter, a word, a character, an animal, an advertisement, a brand, and a name or a nickname.
